(19) United States
(12) Patent Application Publication
(10) Pub. No.: US 2026/0316582 A1
(43) Pub. Date: Oct. 15, 2026

(54) IMPROVED HYDRAULIC SYSTEM FOR SECURING THE BRAKE SYSTEM OF AN ELECTRICALLY DRIVEN VEHICLE

(71) Applicant: POCLAIN HYDRAULICS INDUSTRIE, Verberie (FR)

(72) Inventor: Jean Heren, Verberie (FR)

(73) Assignee: POCLAIN HYDRAULICS INDUSTRIE, Verberie (FR)

(21) Appl. No.: 19/484,176

(22) PCT Filed: May 15, 2024
(86) PCT No.: PCT/FR2024/050621

§ 371 Date: Nov. 13, 2025

(30) Foreign Application Priority Data
May 16, 2023 (FR) FR2304860

(51) Int. Cl. B60L 3/00; B60K 7/00; B60L 1/00; B60L 7/10

(52) U.S. Cl. CPC B60L 3/0076; B60K 7/0007; B60L 1/003; B60L 3/0092; B60L 7/10; B60L 2240/54

(57) ABSTRACT

A system for braking a machinery has an electric motor assembly, a primary circuit, at least one secondary hydraulic circuit having a secondary hydraulic pump, a current storage assembly able to store the current generated by the electric motor assembly operating in the generator mode during nominal operation, a braking member disposed at a discharge of the secondary hydraulic pump and calibrated to be conductive during nominal operation, and to define a restriction on the discharge of the secondary hydraulic pump during a malfunction situation in which the current storage assembly is no longer able to store the current generated by the electric motor assembly.

### TECHNICAL FIELD

The present invention relates to a hydraulic circuit for the braking of machinery with electromechanical or electrohydraulic transmission such as a compactor, but not only.

### PRIOR ART

The electric machineries, in particular the off-road type machines such as the electric roller compactors or other construction, handling or tillage machineries, generally comprise a main circuit performing a primary function such as the transmission for the traction and the movement of the machine, the lifting of a load, or the orientation of a turret, and secondary hydraulic circuits for performing auxiliary functions such as the steering assistance or the generation of the pilot or charge pressures.

Moreover, in such relatively slow off-road electric machineries, it is known, in addition to the manual friction brakes, to use the regenerative braking, the latter constituting an important lever for energy optimization. The regenerative braking consists in temporarily using an electric motor as a generator, in order to generate a resisting torque on the transmission shaft for example. This resisting torque causes the braking of the machinery when it is driven by its own inertia or by gravity, for example.

The electric power thus generated can be stored for example in a battery, with the transmission of this electric power and the charging of the battery being generally managed by a controller, for example a calculator.

However, failure cases in the electric system are likely to limit the retention capacity of the transmission. For example, when the battery is fully charged or at the end of charge, the calculator may limit or even prohibit the return of current to the battery, resulting in the impossibility to generate sufficient retaining torque. Defects such as a malfunction of the calculator itself, a communication fault between the drives and other members, or damage to an electric conductor, preventing the transfer of the generated electric power towards the battery, may also occur.

Given the low inertia and low friction of the electric motor, in case of loss of the battery regeneration capacity, it is virtually impossible to limit the speed of the electric motor and therefore that of the machinery. There is then a significant risk of overspeed in the components within the time interval required to detect a fault and actuate a safety member such as a friction brake or the like.

Existing solutions, such as the creation of a buffer zone in the battery that remains available to accept additional energy if necessary, or the use of electric braking resistors, do not provide a sufficiently satisfactory response in terms of safety and costs.

The present invention thus aims to at least partially address these issues.

### DISCLOSURE OF THE INVENTION

The present disclosure relates to a system for braking a machinery with electromechanical or electrohydraulic transmission, comprising:
an electric motor assembly able to operate in a motor mode or in a generator mode,
a primary circuit adapted to perform a rotation of movement members of the machinery by the electric motor assembly,
at least one secondary hydraulic circuit for performing auxiliary functions of the machinery, comprising a secondary hydraulic pump able to be driven in rotation by the electric motor assembly,
a current storage means able to store the current generated by the electric motor assembly operating in the generator mode during nominal operation,
a braking member disposed at a discharge of the secondary hydraulic pump and calibrated to be conductive during nominal operation, and to define a restriction at the discharge of the secondary hydraulic pump during a malfunction situation in which the current storage means is no longer able to store the current generated by the electric motor assembly.

This configuration allows, in the event of a malfunction preventing the transfer of the electric power generated by the electric motor assembly operating in the generator mode, toward the current storage means, consuming the energy that cannot be absorbed by the current storage means, and thus allows dissipating this energy as heat in the hydraulic fluid of the secondary circuit, by creating a temporary overload on the latter thanks to the braking member. This allows improving the braking safety in case of electrical malfunction, this solution being moreover inexpensive and using hydraulic components already present on these machineries.

In some embodiments, the braking member is mechanically adjustable or remotely pilotable.

In some embodiments, the primary circuit is a hydraulic circuit, the electric motor assembly comprising a single electric motor able to jointly drive in rotation a primary hydraulic pump adapted to supply the primary hydraulic circuit and the secondary hydraulic pump, the secondary hydraulic circuit being a charge circuit and the secondary hydraulic pump being a charge pump, the braking member being adapted to define a restriction at the discharge of the charge pump during the malfunction situation, so as to generate a resisting torque on a shaft of the electric motor driving in rotation the charge pump and the primary pump.

In some embodiments, the electric motor assembly comprises at least one primary electric motor able to perform a rotation of the movement members, and a secondary electric motor able to drive the secondary hydraulic pump, in which during the malfunction situation, the primary electric motor operating in the generator mode is able to transmit the generated electric power to the secondary electric motor operating in the motor mode.

In some embodiments, the system comprises a controller able to pilot the braking member and/or the electric motor assembly to create an overload on the discharge of the secondary hydraulic pump via the braking member during the malfunction situation.

In some embodiments, the primary circuit is an electromechanical circuit, the at least one primary electric motor being able to directly drive a shaft of the movement members, the secondary hydraulic circuit being a cooling circuit for cooling the at least one primary electric motor.

In some embodiments, the primary circuit is a hydraulic circuit, the primary electric motor being able to drive in rotation a primary hydraulic pump adapted to supply the primary hydraulic circuit, the secondary hydraulic circuit being a charge circuit and the secondary hydraulic pump being a charge pump.

In some embodiments, the braking member is a flow limiter, the system further comprising a pressure limiter disposed on the secondary hydraulic circuit at the discharge of the secondary hydraulic pump and in parallel with the flow limiter, and being adapted to let out a fluid flow rate towards a reservoir from a pressure threshold during the malfunction situation, and not to let out any flow rate during nominal operation.

The present disclosure also relates to a method for piloting a system for the braking of a machinery with electromechanical or electrohydraulic transmission comprising:
a primary circuit adapted to perform a rotation of movement members of the machinery by an electric motor assembly able to operate in a motor mode or in a generator mode,
at least one secondary hydraulic circuit for performing auxiliary functions of the machinery, comprising a secondary hydraulic pump able to be driven in rotation by the electric motor assembly,
a current storage means able to store the current generated by the electric motor assembly operating in the generator mode during nominal operation,
a braking member disposed at a discharge of the secondary hydraulic pump, the method comprising the calibration of the braking member so that it is conductive during nominal operation, and so that it defines a restriction at the discharge of the secondary hydraulic pump during a malfunction situation in which the current storage means is no longer able to store the current generated by the electric motor assembly.

In some embodiments, the electric motor assembly and the braking member are piloted by a controller.

In some embodiments, the electric motor assembly comprises at least one primary electric motor able to perform a rotation of the movement members, and a secondary electric motor able to drive the secondary hydraulic pump, the method comprising the detection of the malfunction situation and the piloting of the electric motor assembly so that the primary electric motor operating in the generator mode transmits the generated electric power to the secondary electric motor operating in the motor mode.

In some embodiments, the method comprises the monitoring of the state of charge of the current storage means and, when the charge of the current storage means is greater than or equal to a predetermined threshold value, the monitoring of the braking member so that it defines a restriction at the discharge of the secondary hydraulic pump.

### BRIEF DESCRIPTION OF THE DRAWINGS

The invention and its advantages will be better understood upon reading the following detailed description of different embodiments of the invention given as non-limiting examples. This description refers to the pages of appended figures, on which:

FIG. 1 is a schematic representation of a system according to a first embodiment of the invention.

FIG. 2 is a schematic representation of a system according to a second embodiment of the invention.

FIG. 3 is a schematic representation of a system according to a third embodiment of the invention.

### DESCRIPTION OF THE EMBODIMENTS

The figures represent examples of systems according to different embodiments of the invention, which are distinguished in particular by the fact that the electric motor assembly for driving different members of the system comprises one or more electric motors according to the embodiments.

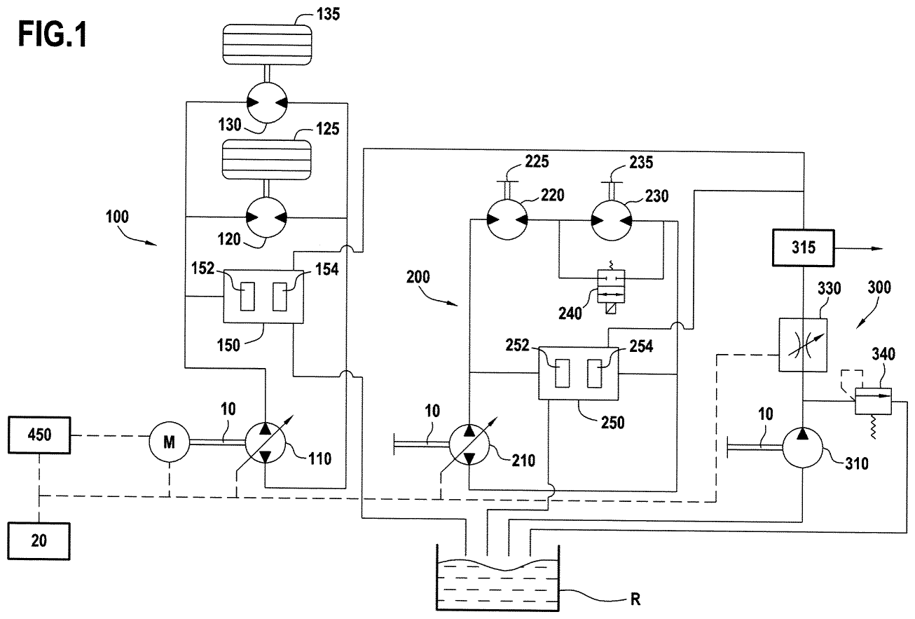

FIG. 1 schematically illustrates the representation of a system according to a first embodiment of the invention, within the framework of an electrohydraulic transmission and in which the electric motor assembly comprises a single electric motor for providing the forward and auxiliary functions.

The system as represented comprises a traction circuit, or primary circuit 100, a secondary vibration circuit 200 and a secondary charge circuit 300.

The primary circuit 100 comprises a primary pump 110, which in this example is a variable-displacement hydraulic pump. The hydraulic pump 110 is connected to two hydraulic motors 120 and 130 adapted to drive in rotation movement members, respectively 125 and 135, of a vehicle or machinery, for example balls or rollers. The nature of the movement members varies depending on the nature of the machinery, in particular whether it is a simple compactor, with a single roller and an axle equipped with wheels, or a tandem compactor with two rollers. Alternatively, for machineries other than a compactor, the movement members could be wheels or tracks. The primary circuit 100 as represented is a closed-loop hydraulic circuit.

The vibration circuit 200 comprises a secondary vibration pump 210 connected to two hydraulic motors 220 and 230 adapted to drive in rotation elements adapted to generate vibrations, for example eccentric masses not represented. In this example, the secondary pump 210 is a variable-displacement hydraulic pump.

In the illustrated example, the two hydraulic motors 220 and 230 are adapted to drive in rotation two vibrating elements, respectively 225 and 235, which typically corresponds to a tandem compactor comprising two rollers. It is understood that in the case of a compactor comprising a single roller, the secondary circuit 200 may then comprise only a single hydraulic motor driving in rotation a single vibrating element.

In the illustrated example, a bypass valve 240 is mounted in parallel with the hydraulic motor 230, which thus allows activating either the two hydraulic motors 220 and 230 or only the hydraulic motor 220. The bypass valve 240 is typically an electrically-controlled valve.

The vibration circuit 200 as illustrated is a closed-loop hydraulic circuit.

The system comprises a single electric motor M. The motor M has a drive shaft 10 adapted to jointly drive in rotation the primary vibration pump 110 and the secondary vibration pump 210. The two pumps 110 and 210 are for example coupled to the same shaft 10 of the primary motor M. In the figures, for clarity of the drawings, the shaft 10 is partially represented, that is to say in an interrupted manner along its length.

The primary pump 110 may for example be a through-shaft pump so as to allow coupling the secondary pump 210. Alternatively, each pump contains a shaft portion and an attachment between the primary pump 110 and the secondary pump 210.

Thus, in operation, the primary motor M will drive in rotation both the primary vibration pump 110 and the secondary vibration pump 210 so as to allow these two hydraulic pumps to deliver a flow rate to supply respectively the primary circuit 100 and the secondary circuit 200.

The system further comprises a secondary charge circuit 300. The charge circuit 300 comprises a secondary charge pump 310 adapted to deliver a charge flow rate.

The charge pump 310 is coupled directly to the shaft 10 of the primary motor M, or via connection means such as gears, so as to be driven in rotation jointly with the primary pump 110 and the secondary pump 210, in the same manner as the driving between the primary vibration pump 110 and the secondary vibration pump 210.

The charge circuit 300 may comprise elements adapted in particular to take a pilot pressure allowing the piloting of different hydraulic members in order to perform for example the hydraulic steering assistance. These elements are generally designated by the reference numeral 315, the detail of these elements not being the object of the invention. The arrow emerging from these elements 315 symbolizes the direction of hydraulic fluid towards the hydraulic members not represented.

The charge circuit 300 is connected to the primary circuit 100 and to the vibration circuit 200 via safety blocks, respectively 150 and 250.

Each safety block 150 and 250 performs a function of protection against overpressures, and of charging of the associated hydraulic circuit. Thus, for the safety block 150, a charge member 152 and a relief member 154 are defined, and for the safety block 250, a charge member 252 and a relief member 254 are defined. Each charge member 152 and 252 typically comprises one or more check valves adapted to perform charging at the inlet of the associated hydraulic pump 110 or 210.

Each relief member 154 and 254 typically comprises a set valve forming a pressure limiter adapted to provide overpressure protection. Each set valve is configured so as to ensure fluid escape as soon as the pressure in one of the ducts of the associated circuit exceeds the setting threshold value. This fluid escape can for example be directed from a duct referred to as high-pressure duct of the circuit towards a duct that is referred to as low-pressure duct of the circuit, or towards the reservoir R.

The setting value of each setting member 154 and 254 is typically defined as a function of the pressures allowable by the various components of the primary 100 and secondary 200 hydraulic circuits, in particular as a function of the maximum pressures allowable by the hydraulic motors 120, 130, 220 and 230. For example, the relief member 154 associated with the primary circuit 100 can be calibrated to a pressure of the order of 350 bar, and the relief member 254 associated with the secondary circuit 200 can be calibrated to a pressure of the order of 210 bar. These pressures depend on the components chosen for each primary or secondary circuit.

Each safety block 150 and 250 thus ensures a minimum pressure in the primary circuit 100 and the secondary circuit 200 via the charge members 152 and 252 as soon as the charge pump 310 is actuated, and performs a pressure relief when the pressure in one of these primary 100 or secondary 200 circuits exceeds a setting value via the relief members 154 and 254.

The system also comprises a controller 20, typically a calculator or an electronic control unit commonly referred to by the acronym ECU.

The controller 20 is adapted to pilot the electric motor M so as to provide sufficient torque to drive the primary pump 110 and the secondary pump 210, 310 so as to achieve desired performances in terms of movement and vibration speed. Preferably, the controller 20 pilots the motor M to provide a power equal to the sum of the powers required for the primary 100 and secondary 200 circuits.

The piloting carried out by the controller 20 is typically carried out based on information and instructions applied by a user, in particular the desired movement speed and the desired vibration frequency.

In operation, the electric motor M drives in rotation the primary pump 110 and the secondary pump 210. The modulation of the displacement of the hydraulic pumps 110 and 210, typically by the controller 20, allows varying the flow rate delivered in the primary circuit 100 and in the secondary circuit 200.

Moreover, the electric motor M is preferably a four-quadrant motor able to operate in a motor mode and in a generator mode in both directions of rotation. In the motor mode, the electric motor M transmits a driving torque to the primary pump 110 which itself actuates the hydraulic motors 120, 130 via the fluid circulating in the primary circuit 100.

Conversely, in the generator mode, the rollers 125, 135 set in rotation for example by the inertia of the machine (the compactor) or in a descent, drive the hydraulic motors 120, 130 and therefore the entire primary circuit 100, in particular the primary pump 110. The latter itself drives the electric motor M which thus generates electric power. The controller 20 monitors the electric motor M to operate in the generator mode, and to transfer the electric power thus generated towards a current storage means 450, for example an electric accumulator such as a battery. This generation of electric power creates a resisting torque on the shaft 10 which, by extension, allows braking the movement members 125 and 135.

The operation described above corresponds to a nominal operation of the machinery, in the absence of any electrical defect or malfunction. Conversely, an electrical malfunction situation (more simply called “malfunction” in the following) implies a situation in which the electric power generated by the motor M can no longer be stored in the current storage means 450, either because the latter is at the end of charge or already fully charged, or because an electrical anomaly prevents this transfer. In this situation, the electric motor M can no longer generate electric current, and can therefore no longer create a resisting torque on the shaft 10 whose speed can therefore no longer be limited by this means.

To overcome this drawback, the system according to the invention comprises a braking member 330 disposed on a secondary circuit, in this example at a discharge of the charge pump 310. The braking member 330 may be a flow limiter, such as a valve, adapted to be conductive or to define a restriction at the discharge of the charge pump 310 depending on the operating conditions.

More specifically, the braking member 330 is provided to be conductive during the nominal operation of the system, and to define a restriction during a malfunction. In other words, the braking member 330 is calibrated such that during the nominal operation, a flow rate of hydraulic fluid remains below a flow rate threshold from which it defines a restriction, and that the flow rate is above this flow rate threshold during a malfunction.

In this example, the braking member 330 is piloted by the controller 20 which detects the occurrence of a malfunction causing the increase in the rotation speed of the motor M, and which consequently adjusts the calibration of the braking member 330 to adjust the degree of restriction of the flow rate generated by the charge pump 310 during the malfunction, and therefore to adjust the resisting torque and the braking induced on the shaft 10.

Alternatively or additionally, the braking member 330 can be mechanically adjusted during the manufacture of the system, in order to be calibrated as a function of the flow rate thresholds defined during the study and dimensioning of the system. Thus, in case of malfunction during the braking of the movement members 125, 135, their inertia will tend to accelerate the motor M. This will lead to an increase in the flow rate delivered by the charge pump 310. When the flow rate becomes greater than the flow rate threshold, the braking member 330 is then engaged so as to restrict the passage of the fluid. Thus, in such an embodiment, the piloting of the braking member 330 by the controller 20 is not required, the triggering threshold being defined by the dimensioning of the braking member 330, making this braking system a passive system.

Whatever the mode used to calibrate the braking member 330 (mechanical calibration or adjustment of the calibration by the controller), the latter allows, during a malfunction, applying a braking torque, and thus performing an energy dissipation function when the storage means 450 can no longer ensure the engine braking function. The temporary overload on the charge pump 310 is directly proportional to the increase in the speed of the electric motor M.

It will further be noted that even when the braking member 330 defines a restriction of the flow during a malfunction, the flow is not entirely blocked and a sufficient flow rate and pressure of the hydraulic fluid flows downstream of the braking member 330, which allows the charge circuit 300 to ensure its charge function including during the period of time during which the braking is done by dissipation of energy on the secondary charge circuit 300.

The controller 20 may be adapted so as to determine the state of charge of the current storage member 450 and to condition the actuation of the braking member 330 on the detection of a state of charge of the current storage member 450 greater than a predetermined threshold value, typically greater than or equal to 90%, greater than or equal to 95%, or equal to 100%. Thus, when the current storage member 450 has a state of charge lower than said threshold value, the energy is dissipated by the electric motor M which is driven so as to restore energy and charge of the current storage member 450. When the current storage member 450 has a state of charge greater than or equal to said threshold value, it can no longer be used to perform an energy dissipation function. The controller 20 then typically actuates the braking member 330.

The system further comprises a pressure limiter 340 disposed on the charge circuit 300, downstream of the charge pump 310 and in parallel with the braking member 330. The pressure limiter 340 is also connected to the reservoir R.

The pressure limiter 340 may be a set valve for ensuring a fluid escape towards the reservoir R when the discharge pressure of the charge pump 310 exceeds a predetermined threshold value, which is here defined by the setting pressure of the pressure limiter 340. Alternatively, the pressure limiter 340 may also be piloted by the controller 20.

The pressure limiter 340 is adjusted so as not to let out any flow rate during nominal operation. In case of malfunction, the pump discharge pressure increases due to the flow rate restriction imposed by the braking member 330, up to the pressure threshold value, for example 200 bar, allowing the opening of the pressure limiter 340. It is therefore understood that the pressure limiter 340, in particular its setting value, defines the maximum possible braking on the shaft 10.

The presence of the pressure limiter 340 allows making the system safe by limiting the risk of excessive pressure at the discharge of the charge pump 310 due to the braking member 330, during the braking phases.

The proposed system and method thus allow optimizing the energy dissipation while maintaining a function of recovering energy and charge of the current storage member 450. They further allow an economical alternative to the existing solutions for safe braking, for example the electric braking resistors, by using hydraulic components (flow limiter, set valve), most of which are already present on the hydraulic systems.

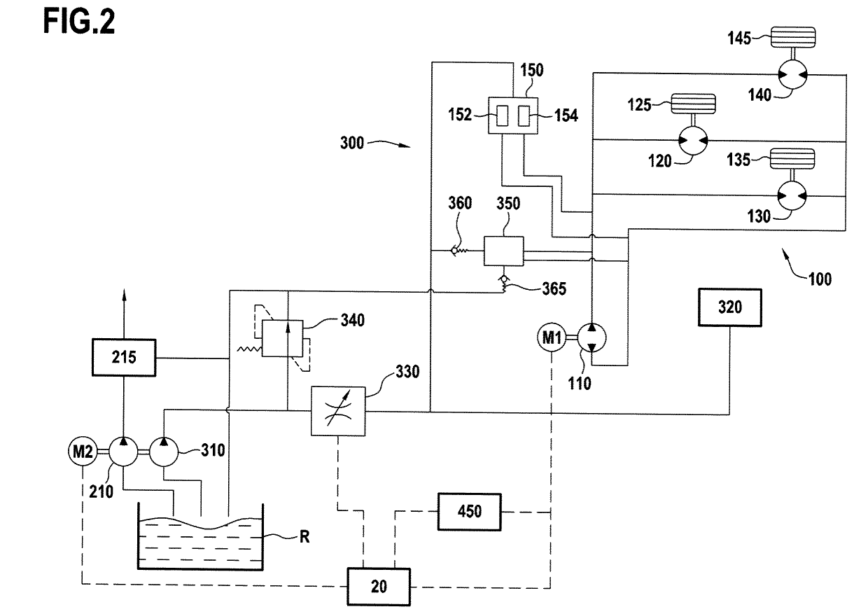

FIG. 2 schematically illustrates the representation of a system according to a second embodiment of the invention, within the framework of an electrohydraulic transmission and in which the electric motor assembly comprises a primary electric motor M1 able to perform a rotation of the movement members, and a secondary electric motor M2 able to drive two secondary hydraulic pumps.

As in the first embodiment, the primary circuit 100 comprises a primary hydraulic pump 110 (with fixed displacement in this example) driven in rotation by the primary electric motor M1, and connected to three hydraulic motors 120, 130 and 140 adapted to drive in rotation movement members, respectively 125, 135 and 145, of a vehicle or machinery, for example balls, wheels or rollers. The primary circuit 100 as represented is a closed-loop hydraulic circuit.

The secondary electric motor M2 jointly drives two secondary hydraulic pumps 210 and 310. The secondary hydraulic pump 210 supplies elements 215 that allow performing auxiliary functions of the machinery such as steering assistance, these elements not being the object of the invention.

The secondary hydraulic pump 310 is a charge pump supplying the charge circuit 300 in a manner similar to the charge circuit described previously with reference to the first embodiment. Particularly, the charge circuit 300 is an open circuit adapted to deliver pressure via the charge pump 310, this charge pressure being used in particular to carry out a charging in the low-pressure duct of the primary traction circuit 100, but it can also be used for the piloting of a brake 320 or for applying pilot pressures. The brake 320 can be connected to the wheels 125, 135, 145. The brake 320 can be a negative brake which is applied in the absence of control pressure, and which is released when pressure is applied.

As within the framework of the first embodiment, the charge circuit 300 is connected to the primary circuit 100 via a safety block 150 comprising a charge member 152 and a relief member 154.

The charge circuit 300 is further connected to a reservoir R via two set check valves 360 and 365 mounted in series and in parallel with the safety block 150. An exchange block 350 is typically interposed between the two set check valves 360 and 365.

The exchange block 350 typically contains a selector for the lower of the two pressures among the two lines of the primary traction circuit 100, and producing a calibrated leak from the lower pressure branch of the primary circuit 100 via the set check valve 365, to renew the oil in the direction of the reservoir R, particularly to ensure its filtration and cooling.

The setting pressure of the set check valve 365 determines the fluid escape from the primary circuit 100 and therefore the fluid flow rate passing through the exchange block 350. Thus, the minimum pressure in the lines of the closed primary circuit 100 is defined by the setting of the outlet valve 365 of the exchange block 350. Furthermore, the setting of the two set valves 360 and 365 defines the charge pressure applied via the exchange block 150 to the primary traction circuit 100.

As in the first embodiment, the charge circuit 300 comprises a braking member 330 disposed at a discharge of the charge pump 310, and a pressure limiter 340 disposed downstream of the charge pump 310 and in parallel with the braking member 330, and moreover connected to the reservoir R. The operation of the braking member 330 (its calibration) and of the pressure limiter 340, in particular during nominal operation and malfunction, is similar to the one described within the framework of the first embodiment.

The controller 20 is configured to pilot the primary electric motor M1 so as to drive in rotation the primary pump 110, to pilot the secondary electric motor M2 so as to drive in rotation the secondary pumps 210, 310, and optionally to pilot the braking member 330 and/or the pressure limiter 340.

During a braking phase within the framework of the nominal operation, the monitoring 20 pilots the primary motor M1 so that it operates in generator mode. The wheels 125, 135, 145 driven by the inertia of the machine drive the hydraulic motors 120, 130, 140 (which then operate as hydraulic pumps), which themselves drive the hydraulic pump 110 (which then operates as a hydraulic motor) driving in rotation the primary motor M1. The electric power thus generated by the latter is transmitted and stored in the battery 450. The resisting torque thus generated on the shaft connecting the primary motor M1 and the hydraulic pump 110 causes its braking, and therefore a braking of the wheels 125, 135, 145.

In case of malfunction, when it is no longer possible to transfer the electric current from the primary motor M1 towards the battery 450, the controller 20 modifies the path of the electric current to transfer the latter from the primary motor M1 towards the secondary motor M2. This electric power surge towards the secondary electric motor M2 causes an increase in its rotational speed and therefore in the rotational speed of the charge pump 310. Given the resulting flow rate increase, and the presence of the braking member 330 appropriately calibrated in the manner described within the framework of the first embodiment, an overpressure occurs at the discharge of the charge pump 310.

Thus, as in the first embodiment, the system allows dissipating the energy created by the increase in the speed of the primary motor M1 during malfunction, as heat in the fluid of the secondary charge circuit 300.

Furthermore, this configuration allows continuing to use the primary motor M1 in generator mode even when it is no longer possible to transfer the current towards the battery 450 (for example because it is fully charged), by transferring the electric current towards the secondary motor M2. It is thus possible for the primary motor M1 to generate electric power equivalent to the one dissipated on the charge circuit 300, allowing the slowdown and safety of the machinery.

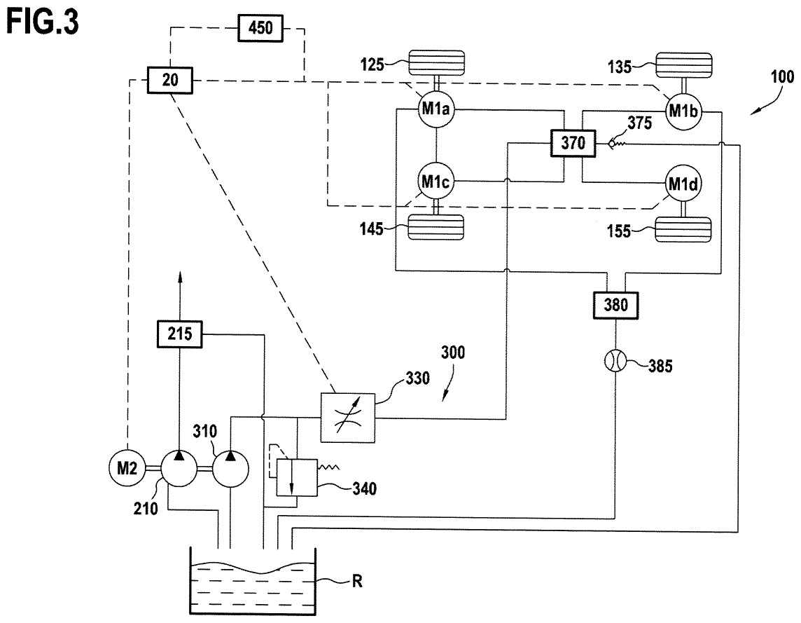

FIG. 3 schematically illustrates the representation of a system according to a third embodiment of the invention, within the framework of an electromechanical transmission and in which the electric motor assembly comprises a first motor unit able to perform a rotation of the movement members, and a second motor unit able to drive two secondary hydraulic pumps.

The primary circuit 100 is an electric circuit comprising the first motor unit, itself comprising four primary electric motors M1a, M1b, M1c and M1d each driving respectively a movement member 125, 135, 145 and 155 of a vehicle or machinery, for example wheels, either directly or via a reducer, of the star type for example but not exclusively. Unlike the hydraulic circuits according to the first and second embodiments, in which the primary motor drives the movement members via a hydraulic pump and hydraulic motors, the primary motors M1a, M1b, M1c and M1d drive in rotation the wheels 125, 135, 145 and 155, either directly at equal speed or via a speed reducer.

The second motor unit comprises a single secondary electric motor M2 jointly driving two secondary hydraulic pumps 210 and 310. The secondary hydraulic pump 210 supplies elements 215 for performing auxiliary functions of the machinery such as steering assistance, these elements not being the object of the invention.

The secondary hydraulic pump 310 allows supplying a secondary cooling circuit 300 for cooling the primary electric motors. Particularly, the cooling circuit 300 is an open circuit taking a liquid (for example oil) from the reservoir R to convey it towards a distributor 370. The distributor 370 distributes the oil towards each of the primary electric motors M1a, M1b, M1c and M1d, upon contact with which a cooling by heat transfer takes place, for example via a heat exchanger (not represented).

A set check valve 375 may be disposed downstream of the distributor 370. Its setting value defines the maximum pressure that can be applied to the fluid intended to cool the primary motors. Beyond this maximum pressure, the set check valve 375 opens and the coolant is then conveyed towards the reservoir R.

The fluid having cooled the motors is then conveyed towards a manifold 380 in which it is mixed and then redirected towards the reservoir R. Optionally, a flow meter 385 is disposed downstream of the manifold 380, making it possible to ensure that the coolant flow rate is sufficient and to adjust the speed of the secondary pump 310, and therefore of the secondary motor M2 accordingly.

The secondary cooling circuit 300 comprises a braking member 330 disposed at a discharge of the secondary pump 310, and a pressure limiter 340 disposed downstream of the secondary pump 310 and in parallel with the braking member 330, and moreover connected to the reservoir R. The operation of the braking member 330 and of the pressure limiter 340, in particular during nominal operation and malfunction, is similar to the one described within the framework of the first two embodiments.

The controller 20 is configured so as to pilot the first motor unit, so as to drive in rotation the wheels 125, 135, 145, 155. Preferably, the controller 20 jointly drives the four primary electric motors M1a, M1b, M1c, M1d. The controller 20 is further configured to pilot the secondary electric motor M2 so as to drive in rotation the secondary pumps 210, 310, and optionally to pilot the braking member 330 and/or the pressure limiter 340.

The method for controlling the various components by the controller 20 in case of malfunction is similar to the one of the second embodiment and allows obtaining the same effects. Particularly, in case of malfunction preventing the transfer of the electric current from the primary motors M1a, M1b, M1c, M1d towards the battery 450, the controller 20 modifies the path of the electric current to transfer the latter from the primary motors towards the secondary motor M2.

The examples described with reference to these three embodiments are not limiting, the invention being applicable to other types of devices and machineries. The invention thus allows making the operation of the system safe in case of defect, while retaining the energy regeneration capabilities during the nominal operating phases, by using components whose robustness and simplicity allow rapid deployment in a large number of applications.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and the drawings should be considered in an illustrative rather than restrictive sense.

It is also obvious that all the characteristics described with reference to one method are transposable, alone or in combination, to one device, and conversely, all the characteristics described with reference to one device are transposable, alone or in combination, to one method.

1. A system for braking a machinery with electromechanical or electrohydraulic transmission, comprising:
an electric motor assembly able to operate in a motor mode or in a generator mode,
a primary circuit adapted to perform a rotation of movement members of the machinery by the electric motor assembly,
at least one secondary hydraulic circuit for performing auxiliary functions of the machinery, comprising a secondary hydraulic pump able to be driven in rotation by the electric motor assembly,
a current storage means able to store the current generated by the electric motor assembly operating in the generator mode during nominal operation,
a braking member disposed at a discharge of the secondary hydraulic pump and calibrated to be conductive during nominal operation, and to define a restriction at the discharge of the secondary hydraulic pump during a malfunction situation in which the current storage means is no longer able to store the current generated by the electric motor assembly.

2. The system according to claim 1, wherein the braking member is mechanically adjustable or remotely pilotable.

3. The system according to claim 1, comprising a controller able to pilot the braking member and/or the electric motor assembly to create an overload on the discharge of the secondary hydraulic pump via the braking member during the malfunction situation.

4. The system according to claim 1, wherein the primary circuit is a hydraulic circuit, the electric motor assembly comprising a single electric motor able to jointly drive in rotation a primary hydraulic pump adapted to supply the primary hydraulic circuit and the secondary hydraulic pump, the secondary hydraulic circuit being a charge circuit and the secondary hydraulic pump being a charge pump, the braking member being adapted to define a restriction at the discharge of the charge pump during the malfunction situation, so as to generate a resisting torque on a shaft of the electric motor driving in rotation the charge pump and the primary pump.

5. The system according to claim 1, wherein the electric motor assembly comprises at least one primary electric motor able to perform a rotation of the movement members, and a secondary electric motor able to drive the secondary hydraulic pump, in which during the malfunction situation, the primary electric motor operating in the generator mode is able to transmit the generated electric power to the secondary electric motor operating in the motor mode.

6. The system according to claim 5, wherein the primary circuit is an electromechanical circuit, the at least one primary electric motor being able to directly drive a shaft of the movement members, the secondary hydraulic circuit being a cooling circuit for cooling the at least one primary electric motor.

7. The system according to claim 5, wherein the primary circuit is a hydraulic circuit, the primary electric motor being able to drive in rotation a primary hydraulic pump adapted to supply the primary hydraulic circuit, the secondary hydraulic circuit being a charge circuit, and the secondary hydraulic pump being a charge pump.

8. The system according to claim 1, wherein the braking member is a flow limiter, the system further comprising a pressure limiter disposed on the secondary hydraulic circuit at the discharge of the secondary hydraulic pump and in parallel with the flow limiter, and being adapted to let out a fluid flow rate towards a reservoir from a pressure threshold during the malfunction situation, and not to let out any flow rate during nominal operation.

9. A method for piloting a system for the braking of a machinery with electromechanical or electrohydraulic transmission comprising:
a primary circuit adapted to perform a rotation of movement members of the machinery by an electric motor assembly able to operate in a motor mode or in a generator mode,
at least one secondary hydraulic circuit for performing auxiliary functions of the machinery, comprising a secondary hydraulic pump able to be driven in rotation by the electric motor assembly,
a current storage means able to store the current generated by the electric motor assembly operating in the generator mode during nominal operation,
a braking member disposed at a discharge of the secondary hydraulic pump, the method comprising the calibration of the braking member so that it is conductive during nominal operation, and so that it defines a restriction at the discharge of the secondary hydraulic pump during a malfunction situation in which the current storage means is no longer able to store the current generated by the electric motor assembly.

10. The method according to claim 9, wherein the electric motor assembly and the braking member are piloted by a controller.

11. The method according to claim 9, wherein the electric motor assembly comprises at least one primary electric motor able to perform a rotation of the movement members, and a secondary electric motor able to drive the secondary hydraulic pump, the method comprising the detection of the malfunction situation and the piloting of the electric motor assembly so that the primary electric motor operating in the generator mode transmits the generated electric power to the secondary electric motor operating in the motor mode.

12. The method according to claim 9, comprising the monitoring of the state of charge of the current storage means and, when the charge of the current storage means is greater than or equal to a predetermined threshold value, the monitoring of the braking member so that it defines a restriction at the discharge of the secondary hydraulic pump.
